(19) United States
(12) Patent Application Publication
(10) Pub. No.: US 2011/0217423 A1
(43) Pub. Date: Sep. 8, 2011

(54) CONFECTIONERY AND METHODS OF PRODUCTION THEREOF

(76) Inventors: Shama Karu Vaman, London (GB); Sarah Jayne Prestwood Pearson, Canberra (AU); Clive Richard Thomas Norton, Shinfield (GB)

(21) Appl. No.: 13/120,522

(22) PCT Filed: Sep. 22, 2009
(86) PCT No.: PCT/GB2009/002259

§ 371 Date: May 23, 2011

(30) Foreign Application Priority Data
Sep. 23, 2008 (GB) 0817369.2

(51) Int. Cl. A23G 3/50; A23P 1/12; A23P 1/08; A23G 3/34; A23G 3/54

(52) U.S. Cl. 426/89; 426/104; 426/512; 426/282; 426/302

(57) ABSTRACT

The present invention relates to a confectionery product comprising a first extruded portion and a second extruded portion, wherein each portion has a plurality of capillaries disposed therein, and the capillaries of the first and second portions are: a) discontinuous; and/or b) continuous and oriented in more than one direction. The present invention also relates to a process for making the same.

### CROSS REFERENCE TO RELATED APPLICATIONS

This is a U.S. national stage of application No. PCT/GB2009/002259, filed on 22 Sep. 2009, which claims priority to GB 0817369.2 filed 23 Sep. 2008, the disclosures of which are incorporated herein by reference.

### TECHNICAL FIELD OF THE INVENTION

The present invention relates to confectionery and method of production thereof. In particular, the invention relates to confectionery comprising a plurality of capillaries which may contain a fluid.

### BACKGROUND TO THE INVENTION

It is desirable to produce confectionery formed of different components, so as to increase sensory pleasure. A number of confectionery products exist, which have a flavoured liquid or syrup centre which is released upon chewing. For example, WO2007056685 discloses an apparatus and method for the continuous production of centre-filled confectionery products in the format of a continuous extrudate having a plurality of centre-filled confectionery ropes. Whilst a product formed from such an apparatus does increase sensory pleasure, the period of pleasure is often short lived as the centre is released quickly and/or degraded. It is therefore an object of the present invention to provide a confectionery product which can release a fluid centre over an extended period of time.

There is also a demand for providing confectionery having a reduced fat or sugar content. It is thus a further object of the present invention to provide a confectionery product which can be produced having a lowered fat or sugar content, whilst still maintaining an excellent sensory pleasure.

It is an aim of an embodiment or embodiments of the present invention to overcome one or more of the problems of the prior art. It is also an aim of one of the embodiments of the present invention to provide a confectionery having an extended fluid fill release profile and a method of manufacture thereof. It is also a further aim of the present invention to provide a confectionery which has a reduced fat and/or sugar profile and a method of manufacture thereof.

### SUMMARY OF THE INVENTION

According to an embodiment of the present invention, there is provided a confectionery product comprising a first extruded portion and a second extruded portion, wherein each portion has a plurality of capillaries disposed therein, and the capillaries of the first and second portions are:
a) discontinuous; and/or
b) continuous and oriented in more than one direction.

The capillaries of each portion may be formed substantially parallel to one another. In one embodiment, the first and second portions are in a stacked configuration, such that the capillaries of the first and second portions are substantially parallel to each other. In an alternative embodiment, the first and second portions are in a folded configuration. In yet another alternative embodiment, the first and second portions are discontinuous and the capillaries are oriented in a random configuration in relation to one another. In some embodiments, the capillaries of the first and/or second portions have a diameter or width of no more than, 3 mm, 2 mm, 1 mm, 0.5 mm, 0.25 mm or less. It is possible to have capillaries having a diameter or width as low as 100 μm, 50 μm or 10 μm. The capillaries of the first and/or second portions may have different widths or diameters.

There may be further portions in addition to the first and second portions, which may or may not comprise capillaries. In one embodiment, the confectionery product comprises the first portion separated from the second portion by one or more further portions that may or may not contain capillaries.

The first and second portions may comprise the same material or different materials. For example, the first portion may be chocolate and the second portion candy. The capillaries in each of the first and second portions may be filled with the same or different materials. One or more capillaries in the first and/or second portions may be filled with different material(s) to other capillaries in the first and/or second portion.

The present invention therefore provides for a confectionery product which can be used in confectionery having an extended release of a material inserted into the capillaries.

The material used to produce the extruded portion may comprise a number of materials commonly use in the production of confectionery—such as candy, gum and chocolate etc.

In some embodiments, the extruded portion is chocolate. Suitable chocolate includes dark, milk, white and compound chocolate. In some embodiments, the extruded portion is chewing gum, bubble gum or gum base. In other embodiments, the extruded portion is candy. Suitable candy includes hard candy, chewy candy, gummy candy, jelly candy, toffee, fudge, nougat and the like.

The capillaries may extend along the substantially entire length of the extruded portion, but may in some embodiment extend no less than 75%, 80%, 90%, 95% or 99% along the length of the extruded portion (for example, when it is desired to seal the ends of the extruded portion). If the capillaries extend along the entire length of extruded portion, suitably the ends of the capillaries are visible at one or more ends of the extruded portion.

One or more of the capillaries may be filled with a material which is different from that of the material used to form the extruded portion. Different capillaries may incorporate different materials if desired. The capillaries may be filled with a fluid material. Such a fluid may comprise a liquid. The capillaries may be filled with a material which is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e.g. a solution of sugars and gelatin will eventually set over time).

Suitable filling materials for the capillaries include, but are not limited to, aqueous media, fats, chocolate, caramel, cocoa butter, fondant, syrups, peanut butter, jam, jelly, gels, truffle, praline, chewy candy, hard candy or any combination or mixture thereof.

If desired, the product may further comprise a coating portion to envelop the extruded portion. The skilled addressee will appreciate that a number of coatings could be employed—for example chocolate, gum, candy and sugar etc.

The extruded portion may be connected to one or more further confectionery portions. In some embodiments, the extruded portion is sandwiched between confectionery materials or may be connected or laminated to one or more confectionery layers. The further confectionery portion or portions may or may not contain inclusions, liquid-filled beads etc.

In some embodiments, the capillaries are distributed substantially uniformly throughout the extruded portion, and may be spaced evenly apart from adjacent capillaries. In other embodiments, the capillaries may be distributed in pre-defined configurations within the extruded portion, such as around the periphery of the extruded portion, or in groups at one or more locations within the extruded portion. In some embodiments the extruded portion has a circular, elliptical, regular polygonal or semi-circular cross-section. The extruded portion may be shaped in the form of a cylinder, a rope, a filament, a strip, a ribbon or the like, or may be shaped in the form of a standard confectionery product such a chocolate bar, or chewing gum slab, pellet, ball, stick or ribbon, for example. The extruded portion may be irregular or regular in shape. Furthermore, the extruded portion may be formed in potentially any shape, for example in the shape of an object, cartoon character or an animal to name a few.

In an embodiment, the capillaries in the extruded portion result in a voidage in the range of 1-99% of the extrudate or 5-99% of the extrudate. The voidage may be in the range of 10-60%, 20-50%, 30-45%, or 35-40%. The voidage may also be in intermediate points in these ranges, for example, 5-40%, 5-45%, 5-50%, 5-60%, 10-40%, 10-45%, 10-50%, 10-99%, 20-60%, 20-45%, 20-40%, 20-60%, 20-99%, 30-40%, 30-50%, 30-60% or 30-99%. The voidage may be over 5%, 10%, 15%, 20%, 25%, 30%, 35%, 40%, 45%, 50%, 55%, 60%, 65%, 70%, 75%, 80%, 85%, 90% or 95%.

The incorporation of capillaries of a small cross-sectional width or diameter enables the capillaries to entrain contrasting or complementary confectionery materials into the extruded portion whilst avoiding the need to incorporate large centre-fill areas which may be prone to leakage-through, or out of, the confectionery product. The use of a plurality of capillaries also enables two or more materials to be incorporated into the confectionery product to give multiple textures, tastes, colours and/or mouth-feel sensations, throughout the whole confectionery product.

In some embodiments, the capillaries have a diameter or width of no more than, 2 mm, 1 mm, 0.5 mm, 0.25 mm or less. It is possible to have capillaries having a diameter or width of no more than 100 μm, 50 μm or 10 μm.

The material of the body portion will preferably be liquid during extrusion. It should be understood that the term “liquid” is intended to mean that the material is capable or has a readiness to flow, including gels, pastes and plasticized chocolate. Furthermore, this term is intended to include (but not limited to) those materials which may be “molten” during extrusion and the skilled addressee will understand that the term “molten” means that the material has been reduced to a liquid form or a form which exhibits the properties of a liquid. The body portion may be at least partially or substantially solid, so that it can no longer be considered to flow in a liquid form.

According to a further embodiment of the invention, there is provided a confectionery product comprising an extruded portion having a plurality of capillaries disposed therein, wherein each capillary is separated from each adjacent capillary by a wall formed from the extruded portion and wherein the wall between each capillary has a thickness of no more than the width or diameter of the capillaries.

According to a further embodiment, there is provided a process for manufacturing a confectionery product comprising a body portion, having a plurality of capillaries disposed therein, the process comprising the steps of:
a) extruding an extrudable confectionery material with a plurality of capillaries disposed therein; and
b) cutting the extrudate into two or more pieces having a plurality of capillaries disposed therein and forming a confectionery product incorporating the pieces; or
c) folding the extrudate and forming a confectionery product incorporating the folded extrudate.

According to yet a further embodiment, there is provided a process for manufacturing a confectionery product comprising a body portion, having a plurality of capillaries disposed therein, the process comprising the steps of:
a) extruding an extrudable confectionery material with a plurality of capillaries disposed therein, wherein the capillaries are continuous and oriented in more than one direction.

Any of the above processes may further comprise the step of depositing a filling in at least part of one or more of the capillaries. The deposition of the filling may be during the step of extrusion—but could also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the extrudate after extrusion. The quench cooling may utilise a fluid, such as air, an oil or liquid nitrogen—but other methods of quench cooling will also be apparent to the skilled addressee.

Any of the processes may further comprise the step of, after extrusion, stretching the extrudate. Stretching the extrudate may be undertaken by a number of means, for example passing the extrudate over, or through conveyor belts or rollers operating at different speeds, so as to stretch the extrudate. By employing this additional step, extrusions having capillaries of a larger diameter can be undertaken, which can be reduced in diameter gradually over time so as to produce an extrudate with smaller capillaries which would have been more difficult to produce. Commonly, capillaries having a bore size of 2 mm or more will be produced during extrusion and these capillaries will be reduced significantly by stretching the extrudate. In some embodiments the capillaries are reduced to no more than 1 mm, 0.5 mm, 0.25 mm, 100 μm, 50 μm, 25 μm or 10 μm.

Any of the processes may further comprise the step of enveloping the confectionery product in a coating. Such a coating will be apparent to the skilled addressee and discussed previously.

The processes may be used for producing a confectionery material as herein above described.

A further embodiment of the present invention provides for apparatus which is adapted for producing a confectionery product according to the processes as herein above described. WO2005056272 discloses an apparatus for producing an extrudated product including a plurality of capillary channels. WO2008044122 discloses a related apparatus, which additionally includes means for quench cooling an extrudate as it exits the die. Both of these apparatus may be employed/adapted for use in producing the confectionery in accordance with the present invention.

### DETAILED DESCRIPTION OF THE INVENTION

Specific embodiments of the present invention will now be described, by way of example only, with reference to the accompanying drawings, in which:

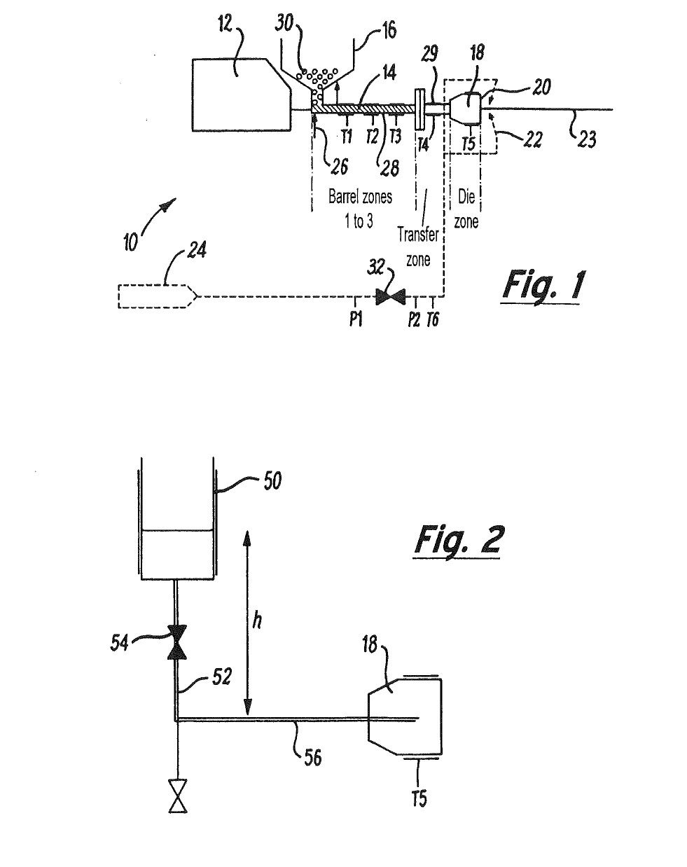

FIG. 1 is a schematic diagram illustrating the overall apparatus used for the experiments described in Examples 1 and 2, in accordance with the present invention;

FIG. 2 is a schematic diagram illustrating the apparatus which can be used in conjunction with the apparatus shown in FIG. 1, so as to provide a liquid filled capillaries;

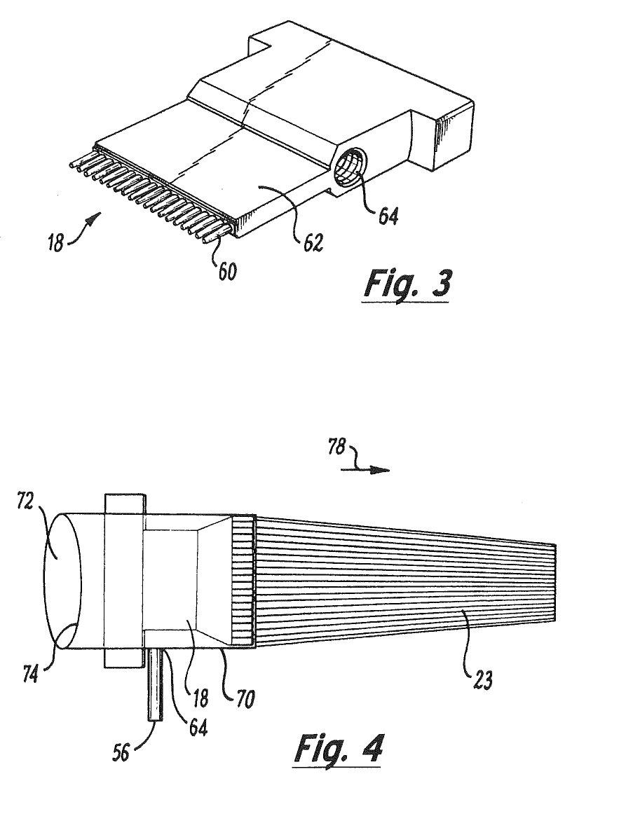

FIG. 3 is a photograph of the extrusion die used to form capillaries in the extruded material of Examples 1 and 2;

FIG. 4 is a plan view of the extrusion die which incorporates the extrusion die shown in FIG. 3 in the apparatus as illustrated in FIGS. 1 and 2;

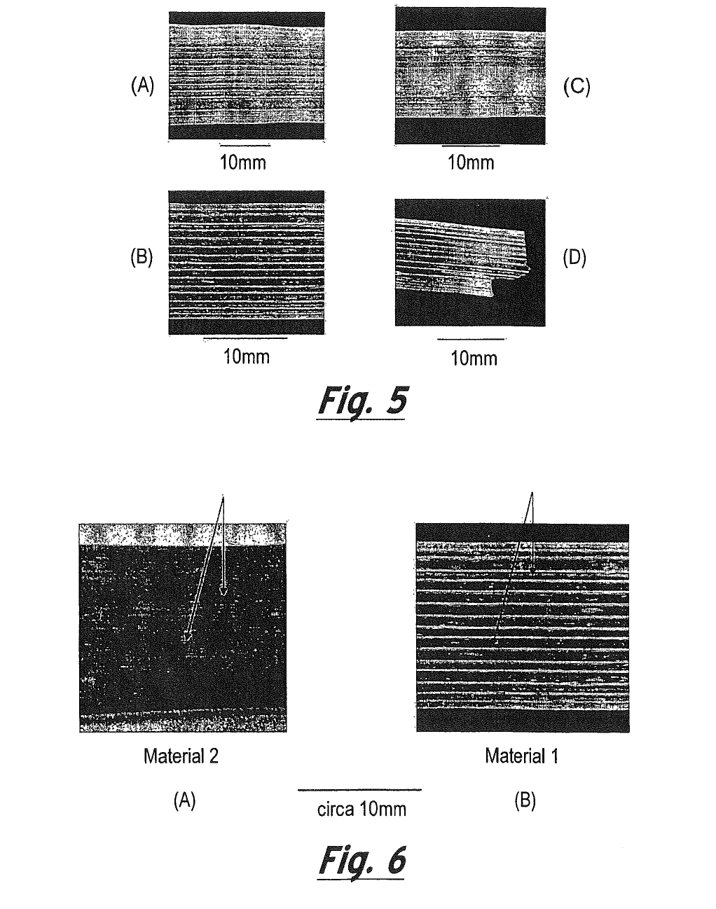

FIG. 5 shows photographs of four capillary extrudates formed from material 1 in Example 1, the photographs show: (A) low voidage, (B) and (C) high voidage and (D) very high voidage;

FIG. 6 shows photographs comparing capillary extrudates formed from (A) material 2 containing completely filled cocoa butter capillaries and (B) material 1 formed with air filled capillaries;

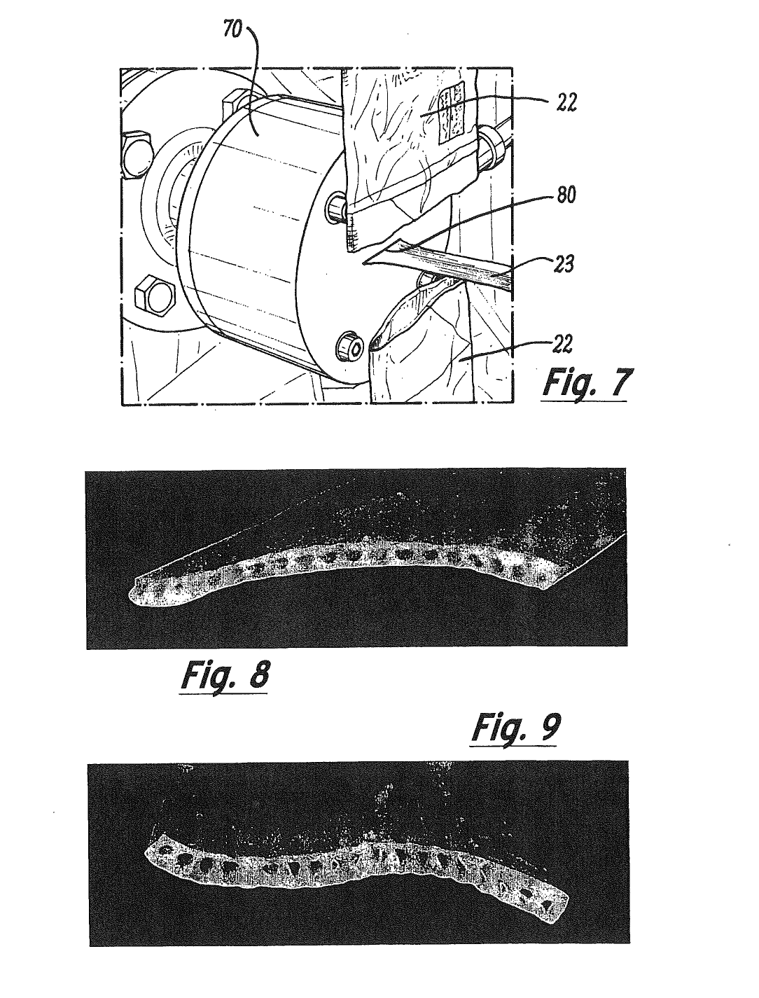

FIG. 7 shows a photograph of the external part of the extrusion apparatus as illustrated in FIGS. 1 and 2, showing the air knives used to cool the extrudate when it exist the die;

FIG. 8 shows a hard candy with an air fill produced in Example 2, in accordance with the present invention;

FIG. 9 shows a hard candy with a liquid fill produced in Example 2, in accordance with the present invention;

FIG. 10 shows a gum with an air fill, produced in Example 2, in accordance with the present invention;

FIG. 11 shows a gum with a liquid fill, produced in Example 2, in accordance with the present invention;

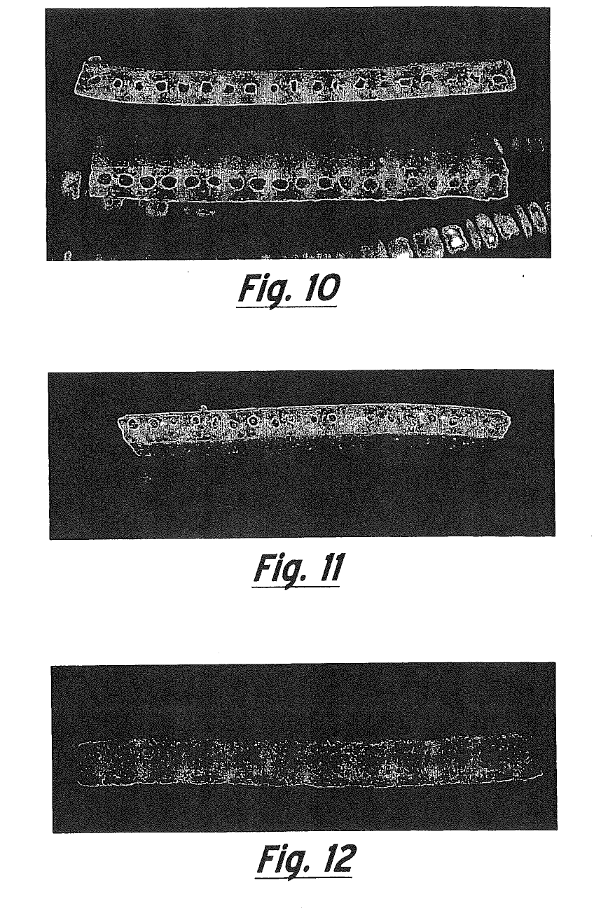

FIG. 12 shows a gum with a solid fill, produced in Example 2, in accordance with the present invention;

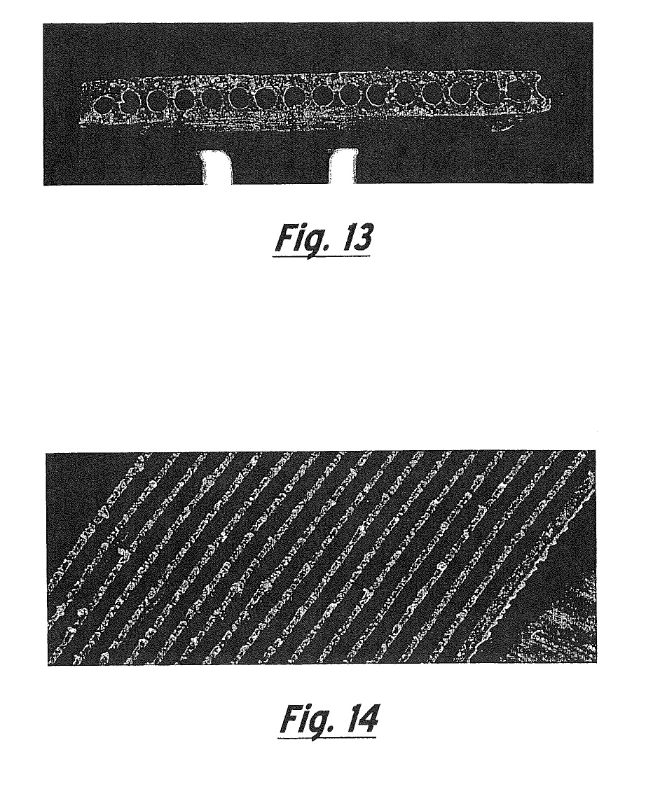

FIG. 13 shows a chocolate with an air fill, produced in Example 2, in accordance with the present invention;

FIG. 14 shows a chocolate with an air fill as shown in FIG. 13, but in longitudinal cross section;

FIG. 15A shows a perspective view of an extrudate formed in accordance with the present invention, where the extrudate has been folded;

FIG. 15B shows a cross-sectional view of the extrudate as shown in FIG. 15A, viewed from the line denoted “X”;

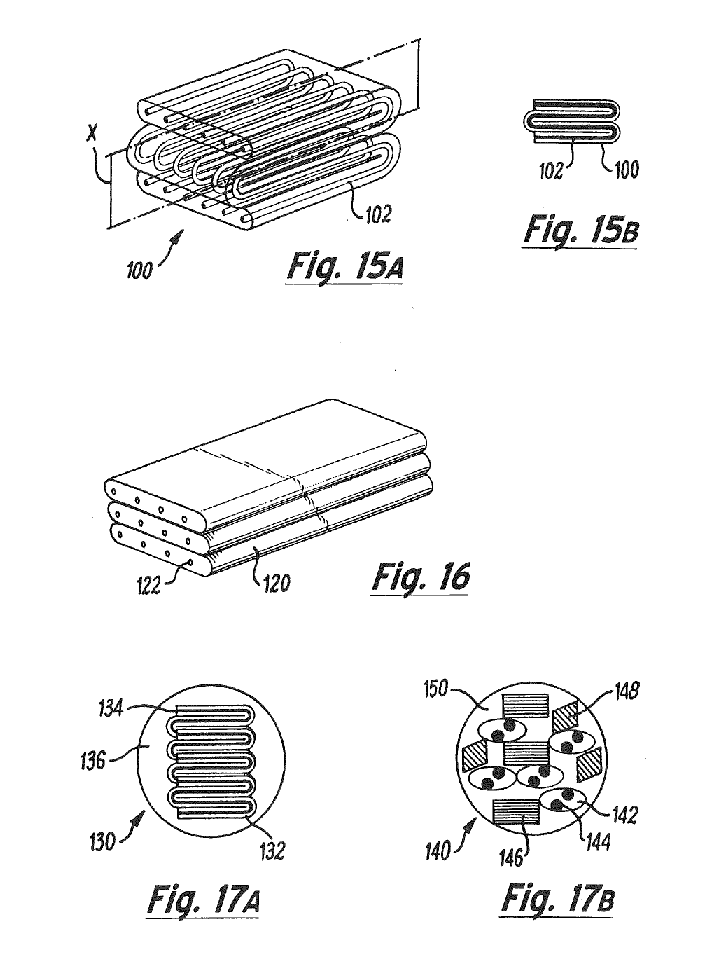

FIG. 16 shows a perspective view of an extrudate formed in accordance with the present invention, where a number of extrudated layers have been stacked upon one another;

FIG. 17A shows a schematic cross-sectional view of an embodiment of a confectionery product in accordance with the present invention, where the capillaries are in a folded configuration;

FIG. 17B shows a schematic cross-sectional view of an embodiment of a confectionery product in accordance with the present invention, a number of small pieces of extruded material have been incorporated into the product in different orientations;

FIGS. 18A and 18B show an embodiment of a confectionery product in accordance with the present invention, where the capillaries are arranged in a double helix. More specifically, FIG. 18A is a cross-sectional view of the product, whereas FIG. 18B is a cut-away side view;

FIGS. 19A and 19B show an embodiment of a confectionery product in accordance with the present invention, where the capillaries are arranged as two helical strands which run close to one another. More specifically, FIG. 19A is a cross-sectional view of the product, whereas FIG. 19B is a cut-away side view; and

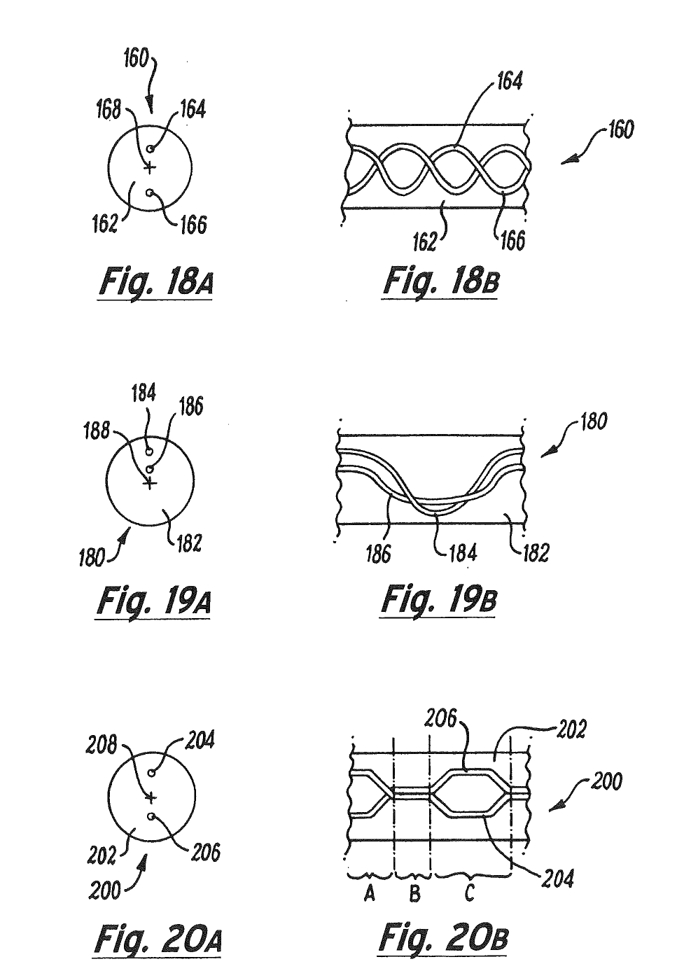

FIGS. 20A and 20B show an embodiment of a confectionery product in accordance with the present invention, where the capillaries are arranged in a wave pattern. More specifically, FIG. 20A is a cross-sectional view of the product, whereas FIG. 20B is a cut-away side view.

Experiments were conducted to produce a variety of confectionery products incorporating capillaries. Three phases of extrusion work were undertaken using various materials. The first phase concerned the extrusion of hard candy using a capillary die attached to a small-scale extruder in a non-food grade environment for creating capillary candy extrudates in both low- and high-voidage forms. The second phase of the experimental work built upon the first phase to produce low and high voidage candy capillary extrudates containing an array of cocoa-butter filled capillaries. The first and second phases are described below in Example 1. The third phase built upon the first two and recreated the working environment with food grade equipment in a food grade environment and is described below in Example 2.

### Example 1

Phase one concerned the extrusion of candy using a capillary die attached to a small-scale extruder, in order to confirm that candy having capillaries with both low and high voidage values could be formed in accordance with the present invention.

The materials that were trialled during this investigation are shown in Table 1.

TABLE 1
Materials tested.

| Material | Material | | |
|---|---|---|---|
| number | name | Majority ingredients | Application |
| 1 | Custom | Sugar (40%) Glucose | Extruded matrix |
| | recipe 1 | Syrup (60%) | |
| 2 | Custom | Maltitol syrup (96%) Gum | Extruded matrix |
| | recipe 2 | Arabic (2%) Water (2%) | |
| 3 | Cocoa butter | Cocoa butter (100%) | Capillary filler |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as candy in solution) which can be heated so as to render it (or maintain it as) a liquid (anything other than a solid or particulate solid). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control T4 before entering the die 18. The die 18 (shown in FIG. 3) has a number of needles (not shown) located within an entrainment body so that the material passes over and around the needles. At the same time that the material is being extruded, compressed air 24 is forced through the needles so that the extrudate contains a number of capillaries. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired.

FIG. 3 shows the die 18 in more detail. In particular, this figure shows that the metallic die 18 has, at one end, a plurality of needles 60 which are joined to a cavity 62 which is in fluid communication with an inlet channel 64 for pumping a fluid material into the capillaries of the extrusion.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has capillaries with no filling or capillaries filled with cocoa butter.

FIG. 7 shows the entrainment body 70 having an opening 80, through which the extrudate is formed. This figure also shows two quench jets 22 located above and below the aperture so as to cool down the extrudate after is has been produced.

In use, the flow of molten material over the tips of the entrainment nozzles (hypodermic needles) caused a small area of low pressure to form at each needle tip. Each nozzle was connected together via internal channeling within the entrainment body. These, in turn, were connected outside the extrusion die to either air at room temperature and pressure or to a molten cocoa butter reservoir, with a hydraulic head of h in FIG. 2. The pipework connecting the die to the cocoa butter reservoir and the cocoa butter reservoir was externally heated to maintain the cocoa butter in the liquid phase. A set of isolation valves were used to switch between either using an air feed to the entrainment body or a molten cocoa butter feed. This is shown schematically in FIG. 2.

The quench jets were used for the generation of the high-voidage material. Differential scanning calorimetry (DSC) was used to examine the thermal behaviour of the materials, such that information relating to the phase transition temperatures could be obtained.

Material 1 was formed in a large solid block. The block was broken up mechanically, such that it became a granulated material with granule sizes between 1 mm and 5 mm.

The extrusion temperature profile was set to that shown in below Table 2.

TABLE 2
Extruder temperature profile for material 1.

| Temperature zone | Label on FIG. 1 |
|---|---|
| Barrel zone 1 | T1 |
| Barrel zone 2 | T2 |
| Barrel zone 3 | T3 |
| Die zone 1 | T4 |
| Die | T5 |

Granulated pieces of material 1 were starve-fed into the extruder, with the extruder screw-speed set to 40 rpm. The granules of material 2 conveyed well into the extruder in the solid phase initially, but due to the sticky nature of the material, some mild feed zone bridging and blocking was observed. This was overcome by gently pushing the broken-up material onto the extruder screw with a polyethylene rod.

Successful capillary extrudates were easily achievable using this protocol. The material had good melt strength and was pulled away easily from the die in the molten state before it set into a brittle, glassy, material. The glassy state of the material meant that it was unsuitable for use in a pair of nip rolls since the compression experienced by the material in this apparatus caused fracture. Consequently, the capillary extrudates from material 1 were hand drawn, the capillaries having an average diameter (width) of less than 4 mm.

Low voidage MCF from material 1 was easily obtained without quenching the extrudate using the quench jets; this is illustrated in the photograph in FIG. 5(A). Enhanced manual hauling of the extrudate away from the die exit coupled with use of the quench jets resulted in high voidage capillary being extruded. The ultimate voidage depended on the speed at which material is hauled away from the die; various different forms of high voidage capillary extrudate formed from material 1 are shown in FIGS. 5(B), (C) and (D). Crude optical analysis of the cross section of material similar to those shown in FIGS. 10 (B) and (C) revealed that voidage between 35% and 40% had been generated. It is highly likely that the high voidage material shown in FIG. 10 (D) was in excess of the value of 35% o 40%.

The second phase of the of extrusion experiments were conducted with material 1 using cocoa butter heated to between 35° C. and 40° C. The head, h, of the cocoa butter reservoir was initially set to 8 cm, and material two fed into the extruder as described earlier. The initial proof of concept was successful, and resulted in the partial filling of the capillaries with molten cocoa butter. It was observed, however, that due to the increased viscosity of the cocoa butter compared to air, the rate at which cocoa butter could be entrained into the extrudate was slow. This problem appeared to be solved by increasing the head of the reservoir to 21.5 cm. It was also observed qualitatively that, in low voidage form, the cocoa-butter filled capillaries appeared somewhat smaller than their air-filled counterparts (less than 3 mm compared to less than 4 mm). It was also possible to create high-voidage cocoa-butter filled capillary extrudates, subject to the coca-butter head being high enough to supply molten cocoa butter at the increased rate.

Material 1 was successfully formed into capillary extrudates, of both high and low voidage, with either airfilled capillaries or cocoa butter-filled capillaries. Varying different voidages films were made, and it was observed that increasing levels of voidage led to increasing fragility. A representative figure for one of the high voidage air-cored films was between 35% and 40% and it is estimated that the very high voidage, highly fragile films, exceeded this.

Material 2 was formed from a mixture of 96% maltitol syrup, 2% gum Arabic, 2% water. Material 2 was shown to act in a similar manner to material 1, in that it was supplied in a large block that was required to be broken up mechanically into smaller granules before it could be fed into the extrusion line. Prior to extrusion experiments commencing, the extrusion die was disassembled and washed and the extruder was fed a hot water wash to dissolve any material 1 remaining within the extruder barrels or on the screw. After the water was purged from the extruder, the extruder was heated to 130° C. for between five and ten minutes to evaporate any remaining water. An early scoping experiment revealed that material 2 required higher extrusion temperatures than material 1; the final extrusion line temperature profile is shown in Table 3 below.

TABLE 3
Extruder temperature profile for material 2.

| Temperature zone | Label on FIG. 1 | Temperature (° C.) |
|---|---|---|
| Barrel zone 1 | T1 | 115 |
| Barrel zone 2 | T2 | 115 |
| Barrel zone 3 | T3 | 115 |
| Die zone 1 | T4 | 115 |
| Die | T5 | 120 |

As with material 1, material 2 was starve-fed into the extruder. As with material 1, the screw speed was set to 40 rpm. Material 2 proved to be easy to extrude and capillary extrudates with air-filled capillaries were produced in both low and high voidage forms. Material 2 exhibited good melt strength, good drawing characteristics prior to solidifying and became brittle and glassy upon solidification. Again, this precluded the use of nip rollers to draw the material from the die and control the amount of draw down achieved, hence manual drawing was used in a similar way to material 1. In terms of restarting the extrusion line after an idle period, material 2 did not prove to be noticeably different to material 1, and the line restarted relatively easily. Due to the ease with which capillary extrudates were achieved, phase one was concluded relatively quickly to allow progression to phase two.

Phase two experiments were conducted with material 2 using cocoa butter heated to between 35° C. and 40° C. The head, h, of the cocoa butter reservoir was kept at 21.5 cm, and material 2 starve-fed into the extruder as described in the previous section. Successful extrusion of both low- and high-voidage micro capillary extrudate from material 2 containing completely filled cocoa-butter capillaries was achieved. A photograph comparing the cocoa-butter filled capillaries of material 2 to the air filled capillaries of material 1 is shown in FIG. 6. Crude optical analysis of a cross section of a piece of high-voidage material 2 revealed that the voidage was roughly 35% at minimum. It is likely this figure can be easily increased through optimisation of the protocol.

The observations for material 2 are similar to those from material 1. Low- and high-voidage capillary extrudates were formed, either containing cocoa-butter capillaries or air-filled capillaries. Crude optical analysis of a moderately high-voidage extrudate revealed that the void fraction was approximately 35%. Although, it is thought that the actual figure may have been higher. Increasing product voidage again led-to-increasing product fragility due to the capillary walls becoming very thin.

The objective of these first and second phase experiments were to provide proof-of-concept for the extrusion of capillary extridates from various candy materials. This was successful with both materials (material 1=40% sugar and 60% glucose, and material 2=96% maltitol syrup, 2% gum Arabic and 2% water). Low- and high-voidage capillary extrudates were formed containing both air-filled capillaries and cocoa-butter filled capillaries. It was estimated that a typical high-voidage extrudate contained roughly 35% to 40% voidage whether it was air filled or cocoa-butter filled.

### Example 2

The third phase built upon the first two phases described in Example 1 and recreated the working environment with food grade equipment in a food grade environment. This food-grade setup extruded hard candy, chocolate and chewing gum with air, liquid and solid centres. This range of filled extrudates were made in a food grade environment and were consumed to investigate their edible properties.

The following edible materials were used in these experiments:

Chewing gum (uncoated Peppermint-Spearmint Higher flavour chewing gum pellets); hard candy, mint candy (Extra Strong Mints®, Jakemans® Old Favourites), fruit candy (Summer Fruits, Jakemans® Old Favourites), chocolate (milk chocolate (with 0, ½, 1, 2% added water), Cadbury® Dairy Milk® Buttons—when used molten, 2% PGPR was added to lower the melt viscosity for ease of use (c.f. legal limit of ½%)), compound chocolate (Plain Belgian Chocolate, SuperCook®), 72% Cook's Chocolate, Green & Black's®. Liquid fillings used in these experiments included: monopropylene glycol (Propane-1,2-diol, BP, EP, USP, Fisher Scientific®—selected for low viscosity, zero moisture, low flavour, and BP, EP & USP grade for oral use), Golden Syrup (partially inverted refiners syrup—Tate & Lyle®—selected for higher viscosity, food grade, shelf stability, and sweet flavour), Red Food Colouring (SuperCook®, UK), Blue Food Colouring (SuperCook®, UK). Lastly, a solid filling of cocoa butter obtained internally from a Cadbury Plc. site was also used in these experiments and this was selected because it is solid at room temperature and has low hot viscosity.

A Davis-Standard HPE-075 ¾″ 24:1 single-screw extruder was used in these experiments. The extruder also included air-knives and a header tank. The screw was a simple conveying-compression-pumping all forward element design, with no mixing or reversing sections. The motor was 3 KW, geared to produce 0-100 rpm screw rotation. The feed throat was jacketed and supplied with flowing ambient water to prevent heat transfer from the barrel causing feed problems with sticky feedstuff. The barrel had three heating zones, each with a 1 KW heater and forced ambient air cooler. The standard extruder has a Eurotherm 3216 controller per barrel zone and one spare for the die (die controller connected to thermocouple input and standard 16A 240v socket for up to 1 KW heater output).

At point of purchase, two additional die controllers, thermocouple inputs and heater outputs were specified to enable integrated control of the header tank containing filling material and the pipework connecting that header tank to the die. The die was an assembly of parts comprising a body with main die orifice of long thin rectangular shape, through which 19 interconnected nozzles (similar in size to hypodermic needles) also exited. The main body was heated and the nozzles led to an external fitting that could be opened to ambient air or could be connected to the heated, pressurized header tank. A bobbin shaped flange was constructed to mount the die assembly onto the extruder end flange.

The die was heated with 4×100W ¼″ cartridge heaters, and monitored by a K-type thermocouple probe. Initially these were controlled by a Eurotherm 3216 in a bespoke enclosure until the control and power wiring was transferred to a Eurotherm integrated into the extruder. The die assembly was earthed into the power outlet from the extruder.

The header-tank and the pipework connecting the header tank to the die were heated with two 100W ribbon heaters initially controlled from a single analogue controller in a bespoke enclosure, and monitored by a single bare K-type thermocouple. These were later separated to two Eurotherm 3216s integrated into the extruder with two thermocouples and two power supplies. The header tank was earthed to the power outlet, whilst the pipework was plastic and did not need to be earthed.

Compressed air, BOC®, UK was regulated with series 8000 gas regulator and pressures used were 0-10 bar. The main use for the compressed air was to supply the air-knives.

Food Safe High-Tech Grease, and Food Safe Penetrating Oil from Solent Lubricants, Leicester, UK was used.

The capillary die was connected on the extruder endplate. Two opposed air knives were used to rapidly quench the extrudate emerging from the extrusion die, were placed above and below the die exit; these jets were connected via a valve to a compressed air line at 10 bar pressure. A schematic diagram showing the general layout of the extrusion line is shown in FIG. 1.

In use, the flow of molten material over the tips of the entrainment nozzles (hypodermic needles) caused a small area of low pressure to form at each needle tip. Each nozzle was connected together via internal channeling within the entrainment body. This, in turn, was connected outside the extrusion die to either air at room temperature and pressure or to a header tank containing a liquid that was at ambient or elevated temperature and pressure, with a hydraulic head of h. The header tank and the pipework connecting to the die were externally heated. A set of isolation valves were used to switch between either using an air feed to the entrainment body or a molten cocoa butter feed. This is shown schematically in FIG. 2.

The quench jets-were used for the generation of the high-voidage material. It had been found during previous research that if the emerging extrudate was quenched very rapidly and subjected to a high drawing force, a higher voidage cross section could be obtained. Adjustment of the polymer and process conditions yielded voidages up to, and possibly in excess of, 60%.

Hard candy was pre-broken before introduction to the extruder. Particle size was not important—the extruder was found to take whole candies or dust. It was found that broken candies fed more evenly than whole pieces. All barrels and the die were set to 95° C. for fruit candy. Mint candy had tolerance to a wide range of temperatures and could run with barrels and die at 95°-110° C.

Screw speeds of 15-100 rpm were used in the experiments. Differences in product were minimal (except rate of production). Continuous, complete, transparent films with well formed capillaries could be produced optimisation of the protocol. The films could be filled and/or drawn without leaking. Product morphology was found to change with drawing speed and rate of cooling inline. Fast drawing with no cooling could thin the films to 1 mm wide with microscopic width and capillaries. Drawing with heavy cooling enlarged the voidage in the films.

In another test, uncoated gum pellets were reduced in size to approximately 3 mm to aid feeding into the extruder. This was done with freezing and a domestic food processor. Barrel and die temperatures of 58° C. resulted in the most contiguous product. This product had sufficient integrity to be filled with few leaks. It is likely that using gum base, in particular molten gum base, rather than whole gum would produce films with even greater integrity.

In a further test, chocolate was used as material for extrusion. To gain stable running conditions, the heaters and cooling fans of the extruder were electrically disabled. Direct temperature control was abandoned in favour of relying on the air conditioning of the laboratory. With these modifications the extruder barrel indicated an even 22° C. and it was simple to extrude capillary chocolate in a steady state using molten tempered Cadbury's Dairy Milk® chocolate.

As with hard candy extrusion, it was possible to draw the chocolate extrudate so as to alter the cross sectional geometry, and produce capillaries having diameters or widths of between 0.5 mm and 4 mm.

Air filling was achieved through a simple ambient air-bleed to the nozzles in the die and a cross section of the extrudate is shown in FIG. 8.

Monopropylene glycol filling was achieved at ambient temperature and pressure, with approximately 5 cm liquid depth in the header tank which was in turn approximately 10 cm higher than the die. Colour was added directly into the header tank as and when required.

Golden Syrup filling was achieved by heating the header tank and pipework to 78° C. to fill hard candy, and 58° C. to fill gum. Pressurisation of the header tank was required at the lower temperature to generate syrup flow. Again, colour was added directly into the header tank as and when required.

FIGS. 8-14 shows photographs of extrusions formed in the third phase of experiments. FIG. 8 shows a hard candy with an air fill. FIG. 9 shows a hard candy with a liquid fill. FIG. 9 shows a gum with an air fill. FIG. 10 shows a gum with a liquid fill. FIG. 11 shows a chocolate with an air fill. FIG. 12 shows a chocolate with an air fill as shown in FIG. 11, but in longitudinal cross section.

Confectionery products and methods of the invention have been shown for chocolate, hard candy and gum. The experiments of the third phase had shown a range of food materials that can also be used. It could therefore be deduced that any product normally solid at room temperature yet extrudable at elevated temperature and pressure could be formed into a capillary product such as chewy, gummy or jelly candies, for example. Products that show high extensional viscosity when warm may be drawn to alter their geometry and their outer to inner ratio.

It has also been shown that air, liquid and solid centres can be incorporated into capillary extrusions, providing the solid centre can be liquefied and is flowable.

It will be apparent to the skilled addressee that the capillary extrudate produced in the examples could be employed in confectionery in a number of ways. For example, a chocolate extrudate having capillaries filled with air could be used to manufacture a chocolate bar having a similar size to a regular bar, but lower in fat and sugar—as it contains less material. Alternatively, a chocolate extrudate could have capillaries filled with a liquid chocolate filling so as to provide an enhanced sensory pleasure. A further example may be a milk chocolate extrudate having capillaries filled with a dark chocolate filling, so as to produce a different flavour profile.

The extrudates of the present invention could be configured in a number of ways. For example, FIGS. 15A and 15B show an extrudate 100 having centre filled capillaries 102, where the extrudate is folded back on it self several times. Such a configuration would enable an extended release of centre fill during chewing. A chocolate éclair could be formed having a chewy centre having liquid filled capillaries—where the chewy centre was a folded several times so as to enable the liquid fill to be released over an extended period.

FIG. 16, shows multiple layers of extrudate 120 being stacked on top of one another and each stack having a plurality of capillaries 122 with a centre filling. Such an arrangement could also be employed in a chewy confectionery.

FIG. 17A shows a cross-section of an embodiment of a confectionery product 130, where the capillaries are in a folded configuration. The confectionery product is formed of a folded extruded portion 132 having a number of capillaries 134 extending the length of the extruded portion. The capillaries 134 are filled, during extrusion, with a liquid fill material. The extruded portion is covered by a coating 136 made from chocolate. When the product is consumed, the liquid filled material is released gradually form the capillaries 134 as they are punctured and/or the material used for the confectionery and coating is degraded.

FIG. 17B shows a cross-section of an embodiment of a confectionery product 140, where a number of small pieces of extruded material have been incorporated into the product in different orientations. The confectionery product is formed with a number of individual pieces of extruded portions being oriented randomly throughout the product. The confectionery product 140 is shown having three differently orientated extruded portions: a first extruded portion 142 is shown “head on” where the capillaries 144 can be seen; a second extruded portion 146 is shown “side on” where the capillaries are not shown; and lastly a third extruded portion 148 is shown to be diagonally orientated where the capillaries can not be seen. The capillaries 144 are filled with a liquid fill and the pieces are located within a hard candy matrix 150. Again, when the product is consumed, the liquid filled material is released gradually form the capillaries 144 as they are punctured and/or the material used for the confectionery and candy matrix is degraded.

With reference to FIGS. 18A and 18B, there is shown a confectionery product 160 which is formed of an extruded hard candy body 162 having a generally cylindrical configuration. Two capillaries 164 and 166 are provided within the body 162, and these extend longitudinally through the body following a helical path. Whilst both capillaries 164,166 extend along two separate helical paths, they are maintained equidistant from one another during the helical turns and are exactly one half turn offset from one another. The helical path of the capillaries are formed by either rotating the extrudate relative to the extrusion die head, or rotating the capillary die head about the axis 168 during extrusion. The capillaries 164,166 are located opposite to one another in opposing planes extending away from the axis 168. If desired, different liquid fondants can be inserted into each capillary 164, 166 during extrusion.

With reference to FIGS. 19A and 19B there is show a confectionery product 180 formed of an extruded hard candy body 182 having a generally cylindrical configuration. Two capillaries 184 and 186 extend longitudinally through the body following a helical path. Both helices follow similar paths about a central axis 188, and the capillaries are located on the same plane extending away from the axis 188. Again, a liquid fondant can be inserted into the capillaries during extrusion.

Lastly, referring to FIGS. 20A and 20B, there is shown a confectionery product 200 which is formed of an extruded hard candy body 202 having a generally cylindrical configuration. Two capillaries 204 and 206 are provided within the body 202, which extend longitudinally through the body following a wave pattern formed of portions of helical turns (denoted A and C) which are interspersed with lateral planar sections (denoted B). Whilst both capillaries extend along two separate paths, they are maintained equidistant from one another during the helical turns and planar sections and they are exactly one half turn offset from one another. The capillaries are located opposite to one another and extend away from a central axis 208 in opposing directions. The helical parts (A and C) are formed by either rotating the extrudate relative to the die head, or rotating the die head during extrusion, whilst the planar sections (B) are formed by preventing the rotation. Once again, a liquid fondant can be inserted into the capillaries during extrusion.

It will of course be apparent to the skilled addressee that a number of other capillary arrangements could be formed in the confectionery if desired if adjustable die heads which could dynamically adjust capillary spacing, pitch and location. Therefore, confectionery products which include convergent, divergent capillaries could be formed along with zig-zag patterns etc.

The foregoing embodiments are not intended to limit the scope of protection afforded by the claims, but rather to describe examples as to how the invention may be put into practice.

1. A confectionery product comprising a first extruded portion and a second extruded portion,
wherein each portion has a plurality of capillaries disposed therein, and the capillaries of the first and second portions are:
a) discontinuous; and/or
b) continuous and oriented in more than one direction
wherein the capillaries of each portion are formed substantially parallel to one another and the width or diameter of the capillaries are substantially uniform and/or the distance between adjacent capillaries remains substantially the same.

2. (canceled)

3. The confectionery product of claim 1, wherein the first and second portions are in a stacked configuration, such that the capillaries of the first and second portions are substantially parallel to each other.

4. The confectionery product of claim 1, wherein the first and second portions are in a folded configuration.

5. The confectionery product of claim 1, wherein the first and second portions are discontinuous and the capillaries are oriented in a random configuration in relation to one another.

6. The confectionery product of claim 1, wherein one or more of the capillaries are at least partially filled with a material which is different from that of the material used to form the first and/or second extruded portion.

7. The confectionery product of claim 1, wherein the capillaries are filled with a fluid material.

8. The confectionery product of claim 7, wherein the fluid comprises a liquid.

9. The confectionery product of claim 1, wherein the capillaries are filled a liquid material which solidifies.

10. The confectionery product of claim 1, wherein the product further comprises a coating portion to envelop the extruded portion.

11. The confectionery product of claim 1, wherein the capillaries in the extruded portion result in a voidage in the range of 5-99%.

12. The confectionery product of claim 1, wherein the capillaries have an average diameter or width of no more than 2 mm.

13. The confectionery product of claim 1, wherein the capillaries having an average width or diameter of no more than 3 mm.

14-16. (canceled)

17. A process for manufacturing a confectionery product comprising an extruded body portion having a plurality of capillaries disposed therein, wherein the capillaries of each portion are formed substantially parallel to one another and the width or diameter of the capillaries are substantially uniform and/or the distance between adjacent capillaries remains substantially the same, the process comprising the steps of:
a) extruding an extrudable confectionery material with a plurality of capillaries disposed therein; and either
b) cutting the extrudate into two or more pieces having a plurality of capillaries disposed therein and forming a confectionery product incorporating the pieces; or
c) folding the extrudate and forming a confectionery product incorporating the folded extrudate.

18. A process for manufacturing a confectionery product comprising a body portion, having a plurality of capillaries disposed therein, wherein the capillaries of each portion are formed substantially parallel to one another and the width or diameter of the capillaries are substantially uniform and/or the distance between adjacent capillaries remains substantially the same, the process comprising extruding an extrudable confectionery material with a plurality of capillaries disposed therein, wherein the capillaries are continuous and oriented in more than one direction.

19. The process of claim 17, wherein the process further comprises the step of depositing a filling in at least part of one or more of the capillaries.

20. The process of claim 17, wherein the filling is deposited during the step of extrusion.

21. The process of claim 17, wherein the filling comprises a fluid.

22. The process of claim 21, wherein the fluid comprises a liquid material which solidifies.

23. The process of claim 17, wherein the process further comprises the step of quench cooling the extrudate after extrusion.

24. The process of claim 23, wherein the quench cooling uses air.

25. The process of claim 17, wherein the process further comprises the step of, after extrusion, stretching the extrudate.

26. The process of claim 17, wherein the process further comprises the step of enveloping the confectionery product in a coating.

27-30. (canceled)
